(19) United States
(12) Patent Application Publication
(10) Pub. No.: US 2025/0173741 A1
(43) Pub. Date: May 29, 2025

(54) METHOD AND SYSTEM FOR CREATING AND UPDATING ENTITY VECTORS

(71) Applicant: LeadChurch Inc., San Diego, CA (US)

(72) Inventors: L. Steven Biafore, San Diego, CA (US); Alejandro Quintero, San Diego, CA (US); Andrish Reddy, San Diego, CA (US); Brendan J. Homnick, San Diego, CA (US); Qlin Hyde, San Diego, CA (US); Bernhard Peters, San Diego, CA (US); Jeff Chang, San Diego, CA (US); Sanjit Singh, San Diego, CA (US); Sean Dwyer, San Diego, CA (US)

(21) Appl. No.: 18/752,681

(22) Filed: Jun. 24, 2024

Related U.S. Application Data
(63) Continuation of application No. 17/348,630, filed on Jun. 15, 2021, now abandoned.
Application No. 17/348,630 is a continuation of application No. 16/027,150, filed on Jul. 3, 2018, now abandoned.
Application No. 16/027,150 is a continuation-in-part of application No. 15/907,165, filed on Feb. 27, 2018, now abandoned.
(60) Provisional application No. 62/528,400, filed on Jul. 3, 2017.

(51) Int. Cl. G06Q 30/0201; G06F 16/22; G06F 16/28

(52) U.S. Cl. CPC G06Q 30/0201; G06F 16/2237; G06F 16/283

(57) ABSTRACT

An entity vector system and method create an entirely real-valued encoding of all dimensions (hereafter referred to as “entity vectors”) for an entity and provides a way to use the relationships among entities along with initial values for entity vectors to create new versions of the entity vectors with more accurate values.

As provided 35 U.S.C. § 120, this is a continuation application, claiming benefit of the filing date of the following U.S. Patent Application, herein incorporated by reference in its entirety:

“METHOD AND SYSTEM FOR CREATING AND UPDATING ENTITY VECTORS,” filed 2021 Jun. 15 (y/m/d), having first-named inventor L. Steven Biafore, and application Ser. No. 17/348,630.

As provided for under 35 U.S.C. § 120, application Ser. No. 17/348,630 is a Continuation application, claiming benefit of the filing date of the following U.S. Patent Application, herein incorporated by reference in its entirety:

“METHOD AND SYSTEM FOR CREATING AND UPDATING ENTITY VECTORS,” filed 2018 Jul. 3 (y/m/d), having first-named inventor L. Steven Biafore, and application Ser. No. 16/027,150.

As provided for under 35 U.S.C. § 120, application Ser. No. 16/027,150 is a Continuation In Part application, claiming benefit of the filing date of the following U.S. Patent Application, herein incorporated by reference in its entirety:

“METHOD AND SYSTEM FOR THE CONSTRUCTION OF DYNAMIC, NON-HOMOGENEOUS B2B OR B2C NETWORKS,” filed 2018 Feb. 27 (y/m/d), having first-named inventor L. Steven Biafore, and application Ser. No. 15/907,165.

As provided for under 35 U.S.C. § 119(e), application Ser. No. 16/027,150 claims benefit of the filing date of the following U.S. Provisional Patent Application, herein incorporated by references in its entirety:

“CREATION, UPDATE AND ANALYSIS OF DYNAMIC, NONHOMOGENEOUS ECONOMIC NETWORKS,” filed 2017 Jul. 3 (y/m/d), having first-named inventor Olin Hyde, and App. No. 62/528,400.

### FIELD

The disclosure relates to the general areas of Sales and Marketing analytics.

### BACKGROUND

Marketers have long collected and used sets of values describing specific characteristic or dimensions of the individual entities (companies, people and other entities) that are relevant to the markets they are working to reach. Typically, each individual entity in a population of entities has its own set of values following the same template (same dimensions, different values). The records for each entity (with the set of values for each entity) may be captured and stored.

Once a database of such records is constructed the marketer may use this data in a variety of ways including querying the database to find sets of individual entities that meet specified criteria. For example, a marketer may execute queries to identify all known companies that have employees in a specific geographical region (Kansas), with annual revenues in a specified range (between $30 million and $70 million) and that sell goods/services mostly to consumers (vs. to other companies).

In many cases, marketers describe their addressable market in terms of these types of queries. The general structure of these query-based descriptions is that they have “sharp boundaries”, in other words they are based upon threshold values such as the revenue range upper and lower bounds in the example above. Continuing with the above example, a company that has a record with annual revenue=$29.999 million does not fall in the range, although it is quite close to the sharp boundary.

In many cases, the data describing a specific characteristic is collected and stored as a categorical value wherein an individual entity is either in or not in any of a number of specific categories (for example, a company is either a healthcare company or it is not, either a manufacturer or it is not, either an education company or it is not and so on for some finite set). In other cases the data is binary (a company either sells to consumers or it does not). In some cases values can assume any real value (ratios, such as revenue per employee, for example). In other cases values are limited to integer values (number of full-time employees, for example). Marketers, in general, specify their queries using a mix of data types (real-valued, integer, categorical, binary, and others). In many cases standards have emerged for specific characteristics (for example SIC and NAICS codes are widely-used codes for a company's industry).

As the amount of data describing individual entities has grown marketers have been able to specify more and more complex queries. With this increase in query complexity it has become increasingly difficult for marketers to understand the boundaries that they are specifying. For example, when these queries are used to specify the population of targets for a marketing campaign it is difficult for marketers to understand the impact of changing the query. Sometimes a small change in a query can produce a very large change in the type and number of entities returned. In other cases a larger change in the query can produce little or no change in the results. In practice, important data values (for example, the industry codes for a given company) are often inaccurate. It is difficult for marketers to know how much these inaccuracies will impact the results of their queries.

The number of dimensions required to capture the relevant aspects of a market, the data inaccuracies and the complexity that arises from mixing different types of values (real, integer, categorical, binary, ordinal and more) make it difficult for marketers to create understandable queries that accurately produce the desired results. This poses a significant problem in the data analytics industry.

### BRIEF DESCRIPTION OF THE DRAWINGS

FIG. 1 illustrates an example of an implementation of an entity vector creation and updating system;

FIGS. 2 and 3 compare a traditional representation with a novel entity vector representation;

FIG. 4 illustrates an example of a cross category structure;

FIG. 5 illustrates a method for creating an entity vector;

FIG. 6 illustrates a method for updating/modifying an entity vector;

FIG. 7A illustrates an example of how people vectors improve company vectors; and

FIG. 7B illustrates an example of how company vectors improve people vectors.

### DETAILED DESCRIPTION OF ONE OR MORE EMBODIMENTS

The disclosure is particularly applicable to a b2b or b2c economic system as disclosed below for illustration purposes and it is in this context that the disclosure will be described. It will be appreciated, however, that the system and method for creating/updating entity vectors has greater utility since it can be used with or be part of any system or method in which it is desirable to be able to generate the disclosed entity vectors. Each entity vector may be for a particular entity in which the entity may be a person, a company, a group within a company, a product, product lines, a service, service lines, an organization, people, a team, capital, content, a school or a capital source. Each entity may be an entity that is important for B2B marketing.

Thus, the system and method provide a technical solution to the above problem and generates and entirely real-valued vector of values that encode entity characteristics for each of the individual entities in a population. The system and method also produces more accurate entity vectors from an initial set of entity vectors and the relationships among them (all or part of the Dynamic B2B network described in the patent application entitled “Method And System For The Construction Of Dynamic, Non-Homogeneous B2b Or B2c Networks” that is incorporated herein by reference. In more detail, the entity vector system and method disclosed below addresses the problem identified above by creating an entirely real-valued encoding of all dimensions (hereafter referred to as “entity vectors”) and by providing a way to use the relationships among entities along with initial values for entity vectors to create new versions of the entity vectors with more accurate values. Note that the disclosed system and method for the entity vector and the entity vector itself is unconventional, not routine and not well understood in the marketing industry as proven in part by the conventional records currently being used by the marketing industry. The detail of what make the disclosed system and method for the entity vector and the entity vector itself is unconventional, not routine and not well understood in the marketing industry are detailed below.

Each entity vector captures a set of characteristics. C={c₁, c₂, . . . , c_{N}} where there is no requirement for any of the values to refer to any specific point or range of points in time. In some embodiments the entity vectors are time-aware. For example, Cₜ={c₁ₜ, c₂ₜ, . . . , c_{Nt}} has values that all relate to the same specific point in time, t. The system and method supports entity vectors with values covering any number of time-slices (like a movie created from a sequence of still images). For example, for any entity vector, C={c₁, c₂, . . . , c_{N}}, there is a dynamic version, C*={(c₁ₜ, c₁ₜ₊₁ . . . c₁ₜ₊ₘ), (c₂ₜ, c₂ₜ₊₁ . . . c₂ₜ₊ₘ), . . . , (c_{Nt}, c_{Nt+1} . . . c_{Nt+m})}All of these embodiments of an entity vector (C, Cₜ and C*) have the same general structure, are within the scope of the disclosure and the disclosed system and method may be applied to all of them. In general, entity vectors may have any number of levels of sub-vectors but when these layers of sub-vectors are flattened into a single level they are simply lists of real numbers. They are real-valued vectors in the mathematical sense. Equivalently, they are points in R^{N} (where N is the number of dimensions in the flattened entity vector).

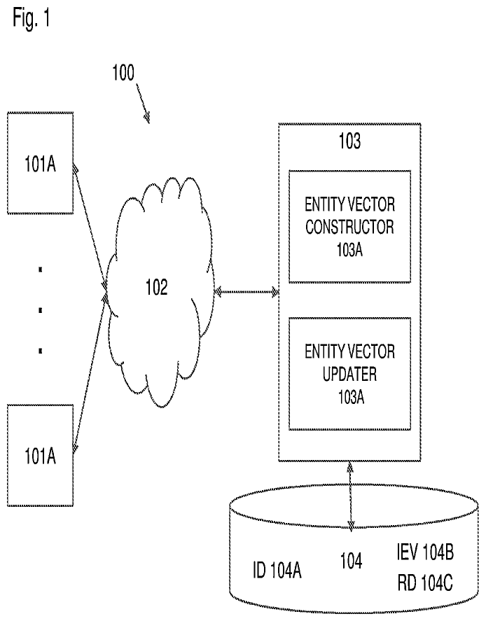

FIG. 1 illustrates an example of an implementation of an entity vector creation and updating system 100. The system 100 may have one or more computing devices 101, such as 101A, . . . , 101N shown in FIG. 1, that connect and communicate over a communication path 102 to an entity vector generation backend 103. Each computing device 101 permits a user to connect to and interact with the backend 103 in order to input an entity vector specification, input entity vector parameters, input entity vector update parameters or input internal or external data used to update an existing entity vector(s) and to receive a visualization of the output generated by the system in the form of a constructed entity vector(s) that can be accomplished using a number of commercially available tools. Each computing device may be a processor based device that may have one or more processors, a memory, a persistent storage device, such as SRAM, DRAM, flash memory or a hard disk drive, a display, input/output devices like a keyboard or mouse or virtual keyboard on a touchscreen of a device and communication circuits that interface with the communication path to communicate data with the backend 103. For example, each computing device 101 may be an Apple iPhone, an Android operating system based device, a personal computer, a laptop computer, a tablet computer, a cluster of dedicated GPUs for a big network hardware optimization and the like. In some embodiments, each computing device may store and execute a browser application, mobile application or application to facilitate the interaction with the backend 103.

The communication path 102 may be one or more wired networks, one or more wireless networks or a combination of wired and wireless networks that communicate data between each computing device 101 and the backend 103. For example, the elements of the communication path 102 may include the Internet, Ethernet, a Attorney Docket No. Lead-002CON [symbol] , a WiFi network and the like. The communication path 102 may use various data transfer and data communication protocols. For example, the communication path 102 may use TCP/IP, HTTPS or HTTP, JSON, HTML and the like.

The backend 103 may be implemented using a plurality of computing resources, such as server computers, blade servers, processors, database servers, application servers, etc. The backend 103 establishes a connection with each computing device 101 over the communication network 102 may receive input from each computing device that may include a request for an output from the backend, an entity vector specification, entity vector parameters, or entity vector update parameters or input internal or external data used to update an entity vector(s). The backend 103 may also construct an entity vector(s) or update an existing entity vector(s) as described below and generate a visualization of the entity vector(s) or updated entity vector(s).

The backend 103 may further comprise an entity vector constructor 103A that has an interface for incoming entity vector data and may process the incoming entity vector data and the entity vector specifications and generate the novel entity vector. The backend 103 may further comprise an entity vector updater 103B that updates an existing entity vector(s). Each or both of the entity vector constructor 103A and the entity vector updater 103B may be implemented in hardware or software. When implemented in hardware, the entity vector constructor 103A and/or the entity vector updater 103B may be a hardware circuit, such as a microprocessor, microcontroller, a state machine, an ASIC, etc. that is configured to perform the processes described below. When implemented in software, the entity vector constructor 103A and/or the entity vector updater 103B may be a plurality of lines of computer code that may be executed by a processor of the computer system that hosts the software so that the processor is programmed and thus configured to perform the various processes and operations as described below. Although the entity vector constructor 103A and the entity vector updater 103B are implemented using known and conventional computer hardware as described above, the processes performed by each of the entity vector constructor 103A and the entity vector updater 103B are not well understood, not conventional and not routine in the marketing industry. For example, the creation of the novel entity vector is not well understood, not conventional and not routine in the marketing industry. Furthermore, the modification/updating of an entity vector is also not well understood, not conventional and not routine in the marketing industry.

The system 100 may further comprise a storage device 104, that may be software or hardware implemented storage device, that stores various data used by the system to generate and/or update dynamic networks. For example, the storage device 104 may store one or more datasets 104A (structured and/or unstructured input data from which an entity vector(s) may be constructed) and/or one or more initial entity vector(s) (IEVs) 104B (previously generated by the system or used as input when an entity vector(s) is updated or modified) and/or one or more relationship datasets (RD) 104C (indicating relationships between or among entities). In addition to the system described above in which the backend performs the entity vector construction or update, in an alternative embodiment, a mobile device processor may perform the entity vector construction or update.

Marketers typically use data records to describe relevant entities (companies, people and others) and these records typically have a mix of data types (text, categorical, binary, integer, real, and others). These records may range from a few data fields (industry, revenue, headcount for example) to several hundred data fields (including, for example, all of the technologies or branded products that a company has purchased and/or all of the types of marketing programs with which the company has experience). The properties of these records that arise from mixed data types and limited information capacity of certain data types (especially binary and categorical types) is the cause of many difficulties and limitations that marketers experience as they use these records to complete common tasks such as defining their target markets, specifying account candidates for campaigns and many other tasks.

The novel entity vectors disclosed below are different in that they encode characteristics data as a set of real numbers (the vector). Entity vectors may optionally have descriptive, index and/or other data that is not real-valued and is used for access, unique identification, display or other purposes. But entity vectors always have entity descriptive data that encoded as real numbers. The encoding of the descriptive data used by marketers in the form of real-numbers is often straightforward (obvious, for example in cases such as using the percentage of a company's customers that are consumers vs. businesses to derive a real-valued representation of the degree to which a company's market is B2B vs. B2C). But, in other cases, for example in the encoding of a company's industry, market to which they sell or supply chain roles they perform, creating a real-valued encoding requires novel methods.

Entity vectors enable a number of fundamentally new functions that are not achievable using current record structures that contain data elements that are not real-valued. Once scaled (using any of a number of well-known scaling processes such as Z-scaling) entity vectors allow single entities (for example, a specific company) to meaningfully be compared to a population of entities (for example, a set of companies that share an important characteristics such as having purchased a particular good or service). This direct comparison is only possible when individual entities and populations of entities have a common data representation. In this example, because real-valued vectors can be combined (for example, by vector addition) to form another real-valued vector of exactly the same structure a population of entities may have (as a population entity) an entity vector of its own of exactly the same form as any individual entity of the same type. In practice, this enables a number of valuable marketing functions such as determining the similarity of a company or person to a population with known behavior or properties (similarity to “best customers”, similarity to “worst customers”, similarity to customers that responded to specific marketing methods, etc.) These similarity operations become difficult or practically infeasible when the data elements describing the relevant entities are not entirely real-valued. The real-valued entity descriptions in the entity vectors also allow marketers to apply all of the mathematics associated with real-valued vector spaces. For example, it is possible to “blend” two entities by averaging them (weighted or unweighted).

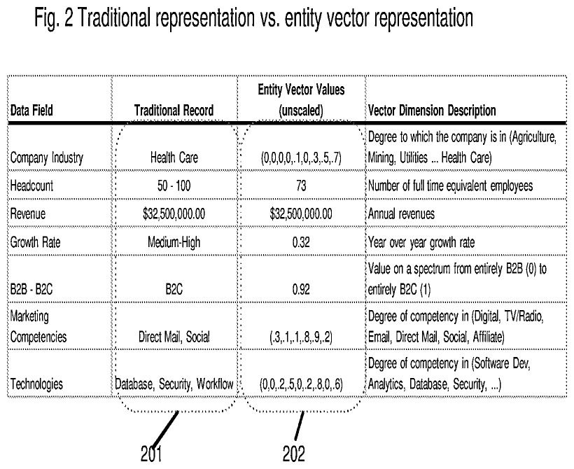

FIG. 2 shows a comparison of an example of a traditional record 201 describing an entity (company) and the corresponding novel and unconventional entity vector encoding 202. In this example note that some types of values in the traditional record 201 (revenue, for example) require no work to encode as real-values, others are straightforward (a company's B2B-B2C mix, for example) while others (industry, for example) require fundamentally new methods. The disclosed novel entity vector includes methods to obtain the real-valued encodings for the latter.

One embodiment of the novel and unconventional entity vector system and method includes methods to create one or more dimensions (these dimensions may be all or part of the full entity vector) of entity vectors that encode specific characteristics that capture a company's core activities, commonly referred to as the company's “industry”. In this specific embodiment, real-valued encodings are produced in the entity vector that overcome many of the significant issues with current encodings of industry.

There are many coding schemes currently used to encode a company's industry. These include the widely adopted standard taxonomies (SIC and NAICS) as well as other schemes developed by organizations (LinkedIn, for example) for particular uses. All of these current schemes have fundamental flaws that are corrected by the novel entity vector and those flaws include:
1. The schemes are categorical (meaning there is a fixed set of options for a company's industry). In these schemes any given company must either be in or out of each category (binary membership). In some schemes a concept of primary category and secondary category exists, but there is no specific mathematical rule that indicates the relative meaning of secondary vs primary membership.
2. The schemes conflate (due to the way users of the scheme interpret the meaning of the possible categories) the concepts of “industry” (a company's core activities), “market” (to whom a company sells its goods/services) and “supply chain role” (the role that the company plays in producing, distributing and/or selling its goods/services).

As an example of the first type of flaw consider 2-digit NAICS codes. Answering the question “What are this company's core activities?” for a company like Apple Inc. is complicated. Clearly Apple Inc. a manufacturer (2-digit NAICS code=33), a retail company (2-digit NAICS code=44), an information and software company (2-digit NAICS code=51), a professional and technical services company (2-digit NAICS code=54) and Apple Inc. also has a significant presence in other industries such as financial services (2-digit NAICS code=52) and entertainment (2-digit NAICS code=71). In many data sources, Apple Inc. will be listed as being in one and only one of these categories. This clearly fails to capture a true and accurate picture of Apple Inc. In the best case, Apple Inc.'s industry will be encoded as being a member of many (perhaps even all of the above) industry categories. This still fails to accurately capture what Apple Inc. does. Even if the concepts of “primary” and “secondary” industry are applied, this type of encoding is still unable to accurately capture what Apple Inc. does because it lacks precision.

The novel and unconventional entity vector addresses this first type of flaw in two ways. First, the entity vector allows a company's membership in any specific industry category to assume any real value as shown in FIG. 2. For example, the entity vector may encode Apple Inc.'s industry as {(0.98 manufacturer), (0.95 retail), (0.87 information), (0.63 professional services), (0.35 financial services), (0.21 entertainment)} with all other categories, such as agriculture, mining, etc. having zero or near-zero values. This approach is capable of encoding more information (using the mathematical definition of information set forth by Claude Shannon (Shannon, C.E. (1948), “A Mathematical Theory of Communication”, Bell System Technical Journal, 27, pp. 379-423 & 623-656, July & October, 1948 that is incorporated herein by reference) than any current scheme constrained to either binary membership in industry categories or the notion of primary/secondary category membership in such categories.

Second, the entity vector supports the use of any number of additional dimensions (not directly dedicated to capturing a company's industry). These additional dimensions of the entity vector provide valuable context that enables human users and/or analytic models to more accurately interpret the entity vector values that are dedicated to encoding industry information. The second type of flaw (conflation of industry, market and supply chain role) is also common in current industry coding schemes. For example, 2-digit NAICS codes include categories for wholesale trade (2-digit NAICS=42) and warehousing (2-digit NAICS=49). Both of these are to a significant degree supply chain roles that may apply to any of a number of different industry categories. Encoding a company's industry as one of these categories leads to significant uncertainty. This second flaw also appears due to the way users of the scheme interpret the categories. For example, the industry of a company that produces and sells hospital management software is, in practice, often encoded as being in the healthcare category (2-digit NAICS=62). This type of inaccuracy is not forced by the encoding scheme but it is made worse by the common conflation of the concepts of “industry” and “market” (in the example, the company's market does include the healthcare category).

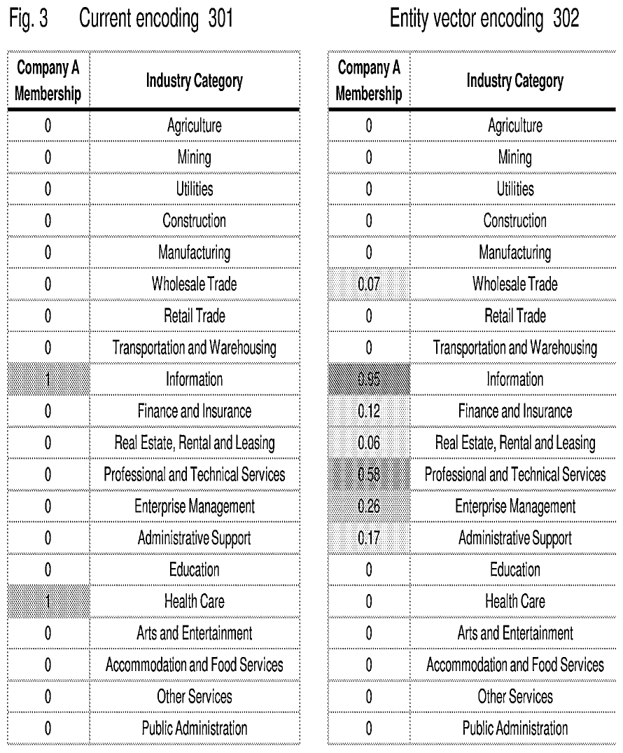

The entity vector addresses this second type of flaw by explicitly separating industry, market and supply chain role. For example, in one embodiment, the entity vector may create an entirely separate sub-vector of the company entity vector that captures the company's market (which may be spread across many different categories of buyers, where buyers may be any of a number of types of entities including companies and individual consumers). FIG. 3 shows an example of a current industry encoding 301 and the corresponding industry subvector encoding 302 enabled by the entity vector. Note that the real-valued encoding is presented using the same categories as the current encoding in order to show the potential to encode more information using the method of the invention. We will later present the new approach to encoding industry that explicitly encodes industry, market and supply-chain role.

Each dimension of the industry sub-vector of the entity vector for a company represents a single industry category and the value for any given company is a real number between 0 (indicating that the company has no membership in the industry category) and 1 (indicating that the company has maximal membership in the industry category). The entity vector is agnostic as to the specific category structure and supports hierarchical category structures with any number of levels.

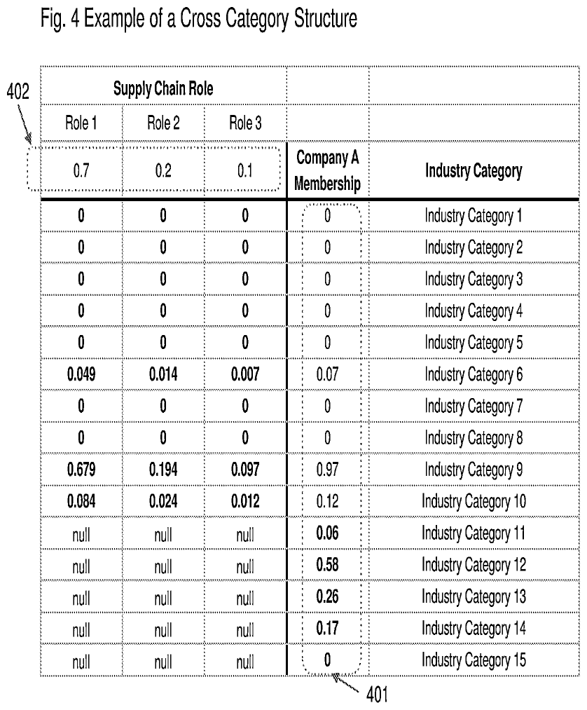

The entity vector may include “cross category structures”. A cross category structure occurs when one category structure (for example, the industry sub-vector) interacts with another (for example the supply-chain role or market sub-vector) to form a new category structure. FIG. 4 shows an example of a cross category structure that relates to the interaction between the sub-vector encoding of company industry 401 and the sub-vector encoding of the company supply-chain role 402. In mathematical terms, a cross category structure is a generalization of the multiplication of two vectors to produce a matrix, with the added ability to exclude any subset of dimensions of either vector from the multiplication process and define which dimensions of the interacting vectors and resulting matrix to include in the cross category encoding produced. In FIG. 4, the first 10 industry categories are included in the vector multiplication and last 5 are excluded (this is a process parameter). All 3 supply chain categories are included in the operation. The process is defined to include the final 5 industry categories in the produced encoding (also a process parameter). The resulting cross category encoding includes all of the numerical values shown in boldface in FIG. 4 where each numerical value represents the entity's degree of membership in the derived category defined by the industry and supply-chain role category(ies) associated with the cell. In practical use, cross-category structures give marketers more power to understand entities than current categorical structures. They achieve this not just because the real-valued encoding carries more information than binary or categorical encodings, but also because they allow marketers to explicitly see how related characteristics (in this example supply-chain role and industry) interact. For example, the marketer may find that although, in general (across all of the industry categories in its customer base), their customers show high concentration in early supply-chain roles, in the case of a specific industry category, the concentration is inverted (much higher in late supply-chain roles). If the marketer looks at supply-chain role and industry separately they will not see this important aspect of their market and may therefore make suboptimal decisions (such as using marketing materials where the examples relate to early supply-chain roles) related to prospects that have high membership in this inverted industry category. The cross category vector interaction process may occur among any number of interacting sub vectors. For example, if three different sub-vectors interact a tensor is produced, and again the process is generalized to allow any subset of any of the interacting vectors to be excluded from the vector multiplication process and any subset of the interacting vectors and/or resulting tensor to be included in the category encoding produced.

In the entity vector, category membership values (for the industry vector or any sub-vector where dimensions represent categories) may be computed using any of a number of well-known estimation methods. In one embodiment a set of statistical or machine learning models are used to produce the category membership estimates. This is done by first identifying a number of both positive exemplars (the entity is in the category) and negative exemplars (the entity is not in the category). This may be done manually, using an algorithm or any combination of manual and algorithmic processes. For each positive and each negative exemplar descriptive data is collected. This descriptive may include any number of structured data elements (such as number of employees and/or annual revenues) and any number of unstructured data elements (such as the words or topics the company has on its website). Using these positive and negative exemplars for each category in a set of categories we may follow any number of well known model development methods (for example, splitting the data into training and validation samples and building a suite of single category classification models or multi-class classification models). The validation data may be used in the usual way to measure classification accuracy. Once built in this way, the classification model (which may include any number of sub-models) may be executed on any set of entities for which we collect a viable subset of the same descriptive information as was used as input to the classification model. Applied in this way, the classification model may be used to create category membership values for any population of entities for which we can collect and/or construct the required descriptive data.

To produce membership estimates for cross category encodings, the disclosed method may create classification models as described above (using any of a number of well known machine learning methods) for each of the interacting category sub-vectors and then apply the generalized vector multiplication process (with parameters indicating scaling, weighting and which parts of the input vectors to include in the generalized multiplication process and which parts of the input vectors or resulting product to include in the output encoding).

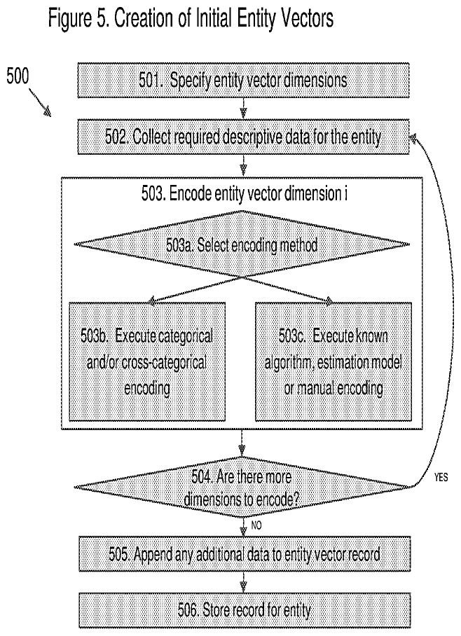

FIG. 5 shows a process 500 for creating initial entity vectors from available data (in general containing values of many different data types including text, categorical, binary, integer, real, and others). The first step is to specify the dimensions of the entity vectors to be constructed 501. For example, in the example in FIG. 2, the dimensions may include company industry, headcount, revenue, growth rate, marketing competencies, technologies and B2B-B2C. The method is agnostic as to the specific set of dimensions chosen. Data that describes a set of entities is collected 502 and used as input to the encoding process 503. For some dimensions, there may be multiple possible encoding methods. In such cases the method is agnostic as to the choice of encoding algorithm 503a. If the dimension encoding method chosen is straightforward encoding logic, estimation model or manual value assignment then the encoding may be executed using that logic 503c (which may take any number of the collected descriptive values as input). If the dimension encoding approach chosen is the novel encoding method 503b then the categorical and/or cross categorical encoding described above (with the company industry example) is executed to achieve the encoding.

The process continues to encode each dimension as long as dimensions remain to be encoded 504. Once all dimensions are encoded for a given entity any additional data is appended 505. This data may include, for example, entity identifier data, human readable fields that add clarity (for example company name and/or address) or other types of data that are not required to assume real-values. Once the data is appended to the constructed entity vector the entity vector with appended data is stored for subsequent use 506.

Note that there are many well-known methods for encoding arbitrary types of data as real-values including computing ratios of known values, measuring the frequency that a specific value occurs across a population of entities, creating a ranking of values by sorting them according to specified criteria and many others. The method is agnostic as to the selection and application of these known methods to transform inputs into a real valued encoding (referred to as “straightforward case” encodings). For example, an example of a straightforward algorithm to compute the value for a dimension of an entity vector that represents the degree to which a company's market is B2B vs. B2C is to assign the dimension a value equal to the percentage of a company's customers that are consumers vs. businesses. Any/all values comprising an entity vector may be created using any combination of direct algorithms, manual processes or network algorithms (that rely upon some set of existing entity vector values and relationships among these entities). In general, any entity vector may have values for some dimensions and lack values for others (partial entity vectors). In one embodiment, this information about entities and the relationships among them is specified in the form of all or part of a dynamic, non-homogeneous B2B Network (described in the already incorporated by reference patent entitled “METHOD AND SYSTEM FOR THE CONSTRUCTION OF DYNAMIC, NON-HOMOGENEOUS B2B OR B2C NETWORKS.”

To this point, enabling the creation and encoding of entity data in the form of real-valued vectors has been described. The values for different dimensions in an entity vector may be created using data elements that are already represented as real numbers, by applying straightforward transformations or by applying processes that allow categorical information (such as company industry or cross category information) to be encoded in the form of real-valued vectors.

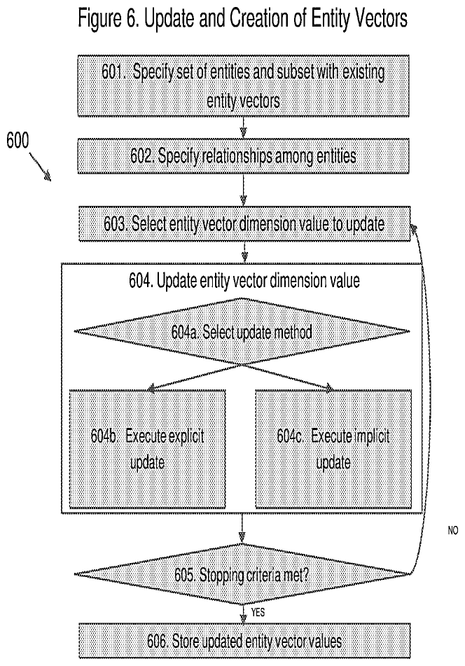

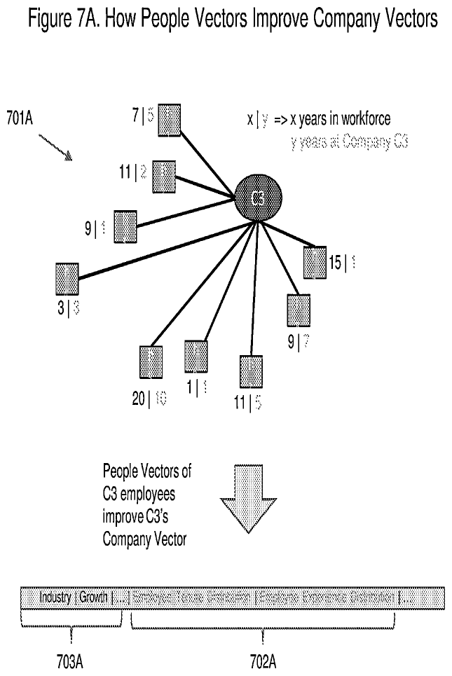

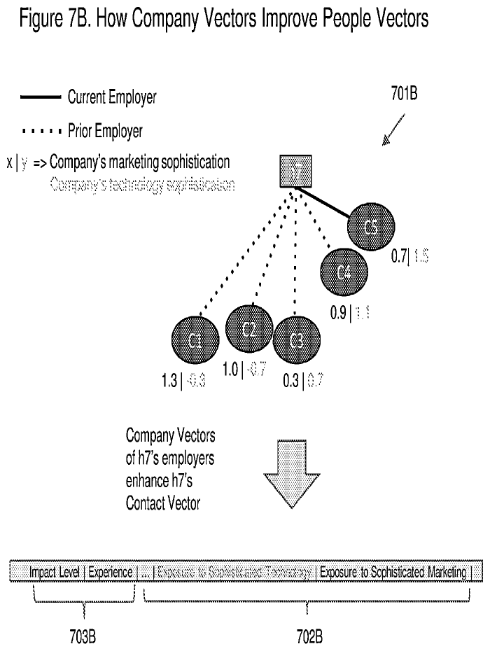

In practical use, for example when a user is trying to understand a market that comprises a population of entities (companies, people or other), the user may desire to improve the accuracy or consistency of values in existing entity vectors, add new data elements (dimensions) to existing entity vectors and/or create entity vectors for entities for which we have little or no direct descriptive information. To help accomplish these tasks, the system and method include a method 600 shown in FIG. 6 wherein a number of existing entity vectors for a set of entities 601 and the relationships among a superset of these entities 602 are input to an update algorithm and a new set of entity vectors is produced (where values within existing entity vectors are modified and/or new dimensions and values are added to existing entity vectors and/or entity vectors are created for new entities). Examples of this modification/update of an entity vector using the explicit update are shown in FIGS. 7A and 7B and are described below in more detail.

In the method, one of the entity vector dimension values is selected for update 603. This may be a random selection or may be done in sequence or accomplished via any of a number of selection criteria. The selection of which entity vector value to update is not particularly important. The idea is to “spin through” all of the values at some point to update them. Doing them in a specific sequence (possibly many time through the sequence) may in some cases lead to suboptimal results, but otherwise it doesn't matter as long as some reasonable process is followed. The entity vector update process 604 is then chosen 604a. The update may be either explicit 604b or implicit 604c. For an explicit update 604b, the relationship information may be used to directly compute values for certain entity vectors using values from certain other entity vectors. An example of explicit update can be seen in the dimension values that we can compute for companies using the values of certain dimensions of the entity vectors for the individual people they employ (for example, one way to estimate a company's collective expertise in a specific technology is to look at the individual expertise of the company's employees).

The purpose of implicit update 604c is to arrive at a more complete set of entity vectors with values for all entity vectors that are increasingly more “fit” with each iteration. The fitness function may be any of a number of well-known functions such as self-consistency and/or accuracy relative to a known benchmark for all or a sample of the entity vector values. In the case of implicit update, there is no known algorithm for using the entity relationship data. Instead, the closeness of one entity to another (using any of a number of well-known graph distance metrics, such as geodesic distance) is used to allow the values for one entity vector to influence the values of another entity. The method is agnostic to the specific approach used to adjust entity vector values. In one embodiment the approach is to create a machine learning model that estimates each of the entity vector values for each entity in the network using all of the other values for entities connected to the entity whose value is being estimated. In another embodiment, we may cluster entities (using any of a number of well known clustering methods such as K-means and agglomerative clustering) using the entity vector data that we do have for a given entity to estimate its membership in each cluster and use properties of the distribution of values within the cluster (such as median) to derive a value for the entity vector dimension being estimated. In all cases, we may use the estimate to fill in a missing entity vector value or to replace an existing entity vector value or update an existing value a blend of the existing value and estimated value. One example of a fitness function is “maximum confidence” where each entity vector value has an associated confidence score and the fitness of a set of values is simply an aggregate measure such as “total confidence” or “median confidence”.

The process continues to iterate through the set of entity vector values being updated 605. Once we have iterated through the entity value update process until stopping criteria have been met 606 (any of a number of well known criteria may be used including convergence criteria and/or time or iteration threshold limits) the update process is halted.

In both the method for creating the entity vector and updating/modifying the entity vector. the method may display the created entity vector or modified/updated entity vector to a user so that the user can take advantage of the novel, unconventional entity vector. In one embodiment, the system 100 shown in FIG. 1 may have a user interface element that is part of the backend and generates a user interface displaying the entity vector to a user of the system, such as using the computing device 101 display.

FIG. 7A shows an example of how one set of entity vectors (in this case the people vectors for a set of employees of a company) can be used to improve (in this case by adding dimensions to) the entity vector for the company. The process takes as input a set of existing entity vectors (in the example shown in FIG. 7A the vectors for employees h₁-h₉ and company C3) and a set of relationships (employment) as shown in the network 701A. The entity vector system and method creates new information about one entity (company C3) using information (how long they have been in the workforce and how long they have been employed by company C3) about another set of entities (h₁-h_{9.} the company's employees). The result is an improved entity vector for Company C3. The new dimensions and their values 702A capture the distributions of work experience and tenure of C3's employee base. These are added to the existing part of C3's entity vector 703A to form a new more informative entity vector. Note that the distribution of employee experience and distribution of tenure are just two of many different employee characteristic whose distributions provide valuable information about the company that employs them. Distribution information may be encoded as real values in a number of well known ways including deciles, quartiles or median, as well as encoding as parameters of well known probability density functions (normal, lognormal, Poisson and many others).

This example shows a single iteration of the process for using a set of entity vectors to improve another (possibly overlapping) set of entity vectors. In general, the process may be iterated many times. Consider, for example, that company vectors for a person's employers (prior and current) can provide valuable information about the person. These company vectors for current and prior employers can tell us, for example, if the person has a history of working for high growth rate companies, if there is a sequential trend in size of the companies the person worked for (increasingly larger or smaller), the industry mix with which the person has the most experience and many other characteristics of one's employers that provide information about the person's skills, preferences, impact etc.). FIG. 7B shows an example where companies C1-C5 that are person h7's current and prior employers are shown in the network 701B. The result is an improved entity vector for person h7. The new dimensions and their values 502B capture the exposure that h7 has had to marketing and technology sophistication at the companies for which h7 has worked. These measures of exposure may be any of a number of aggregation statistics including maximum level of sophistication, median level or distribution of levels across the population of companies for which h7 has worked. These new dimensions are added to the existing dimensions 703B of h7's entity vector. Note that if h7's entity vector already includes dimensions that capture the level of h7's marketing and/or technology skills we may (in addition to adding new dimensions) also modify the existing values (either replacing the prior values or applying any of a number of well known blending functions to incorporate the information about the marketing and technology sophistication of h7's employers into h7's entity vector). Because employee vectors can change company vectors and company vectors can change employee vectors the process may be iterated and terminated via any of a number of methods such as stopping after the magnitude of changes falls below a certain threshold or stopping after a certain number of iterations.

There are many other relationships among entities that enable one set of entity vectors to adjust or add values to another set of entity vectors, the employment relationship is just one of many. For example, the entity vectors of a company's customers (individual consumers, companies or other entities) may tell much about the company selling the goods/services.

A dynamic network object is described in the already incorporated patent application entitled “METHOD AND SYSTEM FOR THE CONSTRUCTION OF DYNAMIC, NON-HOMOGENEOUS B2B OR B2C NETWORKS.” In general, the disclosed entity vector may be applied to any sub-network of a dynamic network object of this type. Entity to entity connections in the dynamic network object include entities that are different versions of the same underlying entity (for example same company, same person) at different times. Sub-networks that include these “same entity different time” relationships provide yet another example of how the invention allows vectors for one set of entities to be used to create or improve the values in the entity vectors for another set of entities. For example, the entity vectors for a company at times t−1 and t+1 (where t−1 might, for example, indicate the year or quarter prior to time t) place constraints on the values for certain dimensions in the entity's vector at time t (for example, maintaining a degree of continuity in headcount and revenue). In this way, we can use entity vector values we have (or in which we have high confidence) to fill in values for entity vectors we might be missing (or in which we have low confidence)

It will be appreciated that both an entity vector taken as a whole (where the data type is a real vector of N dimensions, for any positive integer N) and/or the value for any dimension an entity vector (where the data type is a real number) may be data associated with any node in a dynamic, non-homogeneous B2B or B2C network. As such, the system and method described in METHOD AND SYSTEM FOR THE CONSTRUCTION OF DYNAMIC, NON-HOMOGENEOUS B2B OR B2C NETWORKS may be applied to the entity vector or any dimension of an entity vector to create or update said value(s). This allows us to create entity vectors and their component values and/or modify entity vectors and their component values using the information contained in an existing dynamic, non-homogeneous B2B or B2C network.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers,. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices. etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics, Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method for creating an entity vector, comprising:
providing an entity vector having one or more marketing oriented dimension data fields, each data field capable of storing a set of one or more real numbers;
creating an entity vector for a particular entity by encoding information about the particular entity into the entity vector, the information being one or more real numbers; and
displaying the created entity vector for the particular entity.

2. The method of claim 1, wherein creating the entity vector further comprises generating an industry sub-vector that is part of the entity vector for the particular entity, the industry sub-vector having a plurality of industry categories wherein each industry category has a real number value.

3. The method of claim 1, wherein encoding information about the particular entity further comprising assigning a real number between a zero value and a one value, wherein the zero value indicates an entity with no membership in a dimension and the one value indicates a maximal membership in the dimension.

4. The method of claim 2, wherein encoding information about the particular entity further comprising assigning a real number between a zero value and a one value, wherein the zero value indicates an entity with no membership in a dimension and the one value indicates a maximal membership in the dimension.

5. The method of claim 1, wherein creating the entity vector further comprises encoding the information about the particular entity using a cross category encoding when a category structure interacts with a second category structure.

6. The method of claim 1, wherein the particular entity is one of a company, a group within a company, a product, product lines, a service, service lines, an organization, people, a team, capital, content, a school and a capital source.

7. The method of claim 1, wherein the one or more dimensions are an industry category, headcount, revenue, growth rate, B2B-B2C, marketing competencies and technologies.

8. The method of claim 1 further comprising specifying the one or more dimensions for the particular entity.

9. A method for updating an entity vector, comprising:
retrieving an entity vector, the entity vector having one or more marketing oriented dimension data fields, each data field capable of storing a set of one or more real numbers;
selecting one or more dimension values of the entity vector to be updated; and
updating each selected dimension value of the entity vector.

10. The method of claim 9, wherein updating the selected dimension value further comprises executing an explicit update in which information in the entity vector is updated by directly computing updated information for the entity vector.

11. The method of claim 9, wherein updating the selected dimension further comprises executing an implicit update using a fitness function wherein a value in a first entity vector influences a value of the entity vector being updated.

12. The method of claim 9, wherein retrieving the entity vector further comprising retrieving a set of entities, an entity vector for each entity and relationship data of the set of entities.

13. The method of claim 9, wherein the entity is one of a company, a group within a company, a product, product lines, a service, service lines, an organization, people, a team, capital, content, a school and a capital source.
